(19) United States
(12) Patent Application Publication
(10) Pub. No.: US 2024/0345594 A1
(43) Pub. Date: Oct. 17, 2024

(54) OBSTACLE AVOIDANCE RESTAURANT SERVING ROBOT WITH ADAPTIVE POSITIONING AND ADAPTIVE POSITIONING METHOD

(71) Applicant: RGT Inc., Daejeon (KR)

(72) Inventor: Ho Jeong JEONG, Daejeon (KR)

(73) Assignee: RGT Inc., Daejeon (KR)

(21) Appl. No.: 18/402,403

(22) Filed: Jan. 2, 2024

(30) Foreign Application Priority Data
Apr. 11, 2023 (KR) 10-2023-0047200

(51) Int. Cl. G05D 1/622; G05D 1/24

(52) U.S. Cl. CPC G05D 1/622; G05D 1/24; G05D 2105/31; G05D 2111/10; G05D 2111/20

(57) ABSTRACT

The present invention relates to an obstacle avoidance restaurant serving robot with adaptive positioning and an adaptive positioning method, and more specifically, to a restaurant serving robot capable of obstacle avoidance and adaptive positioning to provide efficient and unhindered service to users, and an adaptive positioning method.

### CROSS-REFERENCE TO RELATED APPLICATION

This application claims priority to and the benefit of Korean Patent Application No. 10-2023-0047200, filed on Apr. 11, 2023, the disclosure of which is incorporated herein by reference in its entirety.

### BACKGROUND

### 1. Field of the Invention

The present invention relates to an obstacle avoidance restaurant serving robot with adaptive positioning and an adaptive positioning method, and more specifically, to a restaurant serving robot capable of obstacle avoidance and adaptive positioning to provide efficient and unhindered service to users, and an adaptive positioning method.

### 2. Discussion of Related Art

Existing restaurant serving robots have been designed to navigate a predefined path and stop at a specified position near a user's table.

However, these robots often faced difficulties when encountering obstacles such as furniture, objects, or people in their path.

These obstacles can hinder the robot's ability to provide timely and efficient service, leading to customer complaints and potential delays in restaurant operations.

Therefore, there is a need for improved serving robots that can adapt to environments, avoid obstacles, and specify optimal positions in order to provide efficient and unhindered service to users.

Accordingly, the present invention proposes an obstacle avoidance restaurant serving robot with adaptive positioning and an adaptive positioning method in order to provide efficient and unhindered service to users.

### RELATED ART DOCUMENTS

### Patent Documents

(Patent Document 1) Korean Patent Registration No. 10-2331177
(Patent Document 2) Korean Patent Registration No. 10-2242380

### SUMMARY OF THE INVENTION

The present invention is directed to providing a restaurant serving robot capable of obstacle avoidance and adaptive positioning to provide efficient and unhindered service to users, and an adaptive positioning method.

According to an aspect of the present invention, there is provided an obstacle avoidance restaurant serving robot with adaptive positioning, including a main body 110 configured to accommodate components of the robot, including a control system, a power source, and a serving tray 150, a plurality of wheels 120 formed on a lower side of the main body to move and support the main body, a navigation system 130 which includes sensors such as a camera, a light detection and ranging (LIDAR) sensor, an ultrasonic sensor, etc. to determine a position of the robot and allow the robot to move to a user's table when a signal is received from a call button, and an adaptive positioning mechanism 140 configured to draw expanding circles based on a predetermined position near the user's table, identify an arc of an expanding circle with no obstacles, allow the robot to move along a selected arc, and specify an optimal position in order to provide service to the user.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram of a restaurant serving robot according to an embodiment of the present invention;

FIG. 2 is a flowchart for describing the operations of a navigation and adaptive positioning process of a robot;

FIG. 3 is a plan view of a serving area showing the expanding circle and arc-based positioning of a robot; and

FIG. 4 is a side view of a robot positioned along arcs of expanding circles for optimal serving.

### DETAILED DESCRIPTION OF EXEMPLARY EMBODIMENTS

An obstacle avoidance restaurant serving robot with adaptive positioning according to an embodiment of the present invention includes a main body 110 configured to accommodate the components of the robot, including a control system, a power source, and a serving tray 150, a plurality of wheels 120 formed on a lower side of the main body to move and support the main body, a navigation system 130 which includes sensors such as a camera, a light detection and ranging (LIDAR) sensor, an ultrasonic sensor, etc. to determine a position of the robot and allow the robot to move to a user's table when a signal is received from a call button, and an adaptive positioning mechanism 140 configured to draw expanding circles based on a predetermined position near the user's table, identify an arc of an expanding circle with no obstacles, allow the robot to move along a selected arc, and specify an optimal position in order to provide service to the user.

In this case, the navigation system 130 may continuously monitor the robot's surroundings for obstacles and adjust the robot's path accordingly to avoid the obstacles.

In this case, the adaptive positioning mechanism 140 may select an optimal arc segment along the expanding circle on the basis of real-time obstacle detection and predetermined position near the table.

In this case, a point where a straight line in a direction in which the robot travels and the arc of the expanding circle meet may become a modified position where the robot provides the service to the user.

In this case, the wheels 120 of the robot may be configured to be adapted to a curvature of the selected arc segment to allow the robot to move smoothly and stably along the arc.

Meanwhile, an adaptive positioning method of a restaurant serving robot includes an operation S210 of receiving a signal from a call button pressed by a user, an operation S220 of starting a navigation system to determine a specified position of a corresponding table, an operation S230 of moving the robot to the specified position while continuously monitoring the surroundings for obstacles, an operation S240 of drawing expanding circles based on a predetermined position near the table using an adaptive positioning mechanism, an operation S250 of evaluating an arc of the expanding circle to identify a portion with no obstacles, an operation S260 of selecting an optimal arc segment along which the robot is able to move and specifying a position for serving, an operation S270 of moving the robot along the selected arc segment while maintaining active monitoring of sensors for environmental changes or newly detected obstacles, and an operation S280 of reaching a contact point between a straight line in a direction of movement and the arc of the expanding circle to provide service to the user at a modified position.

In this case, the adaptive positioning method may further include adapting wheels of the restaurant serving robot to a curvature of the selected arc segment to move the robot smoothly and stably along the arc.

Hereinafter, examples of the obstacle avoidance restaurant serving robot with adaptive positioning and the adaptive positioning method according to the present invention will be described in detail.

In an embodiment, the robot of the present invention includes a navigation system that helps the robot reach a specified position of a corresponding table.

The navigation system is configured as various sensors such as a camera, a LIDAR sensor, an ultrasonic sensor, etc. to detect obstacles and identify a position of the robot in real time.

In another embodiment, the adaptive positioning mechanism of the robot is configured to draw expanding circles based on a predetermined position near the table.

Thereafter, the robot may identify an arc of an expanding circle with no obstacles, which allows the robot to move along the arc, and specify an optimal position to provide service to the user.

In this case, a contact point between a straight line in a direction in which the robot moves and the arc of the expanding circle becomes a modified position where the robot provides service to the user, and may allow the robot to continue providing the service without being hindered by obstacles.

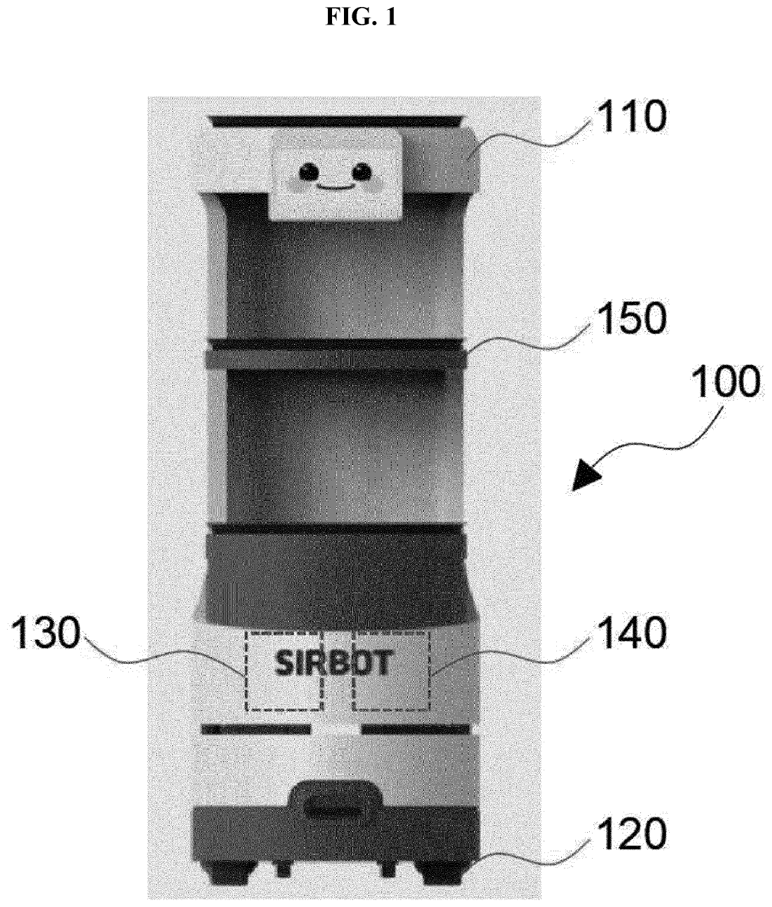

FIG. 1 is a schematic diagram of a restaurant serving robot according to an embodiment of the present invention.

As illustrated in FIG. 1, a restaurant serving robot 100 includes a main body 110, a plurality of wheels 120, a navigation system 130, an adaptive positioning mechanism 140, and a serving tray 150.

The navigation system 130 allows the robot to determine its position and move to a user's table when a call button is pressed.

The navigation system 130 is equipped with sensors such as a camera, a LIDAR sensor, an ultrasonic sensor, etc. to detect obstacles and identify a position of the robot in real time.

The adaptive positioning mechanism 140 may allow the robot to draw expanding circles based on a predetermined position near a table.

Thereafter, the adaptive positioning mechanism 140 may allow the robot to identify an arc of an expanding circle with no obstacles, move along the arc, and specify an optimal position in order to provide service to a user.

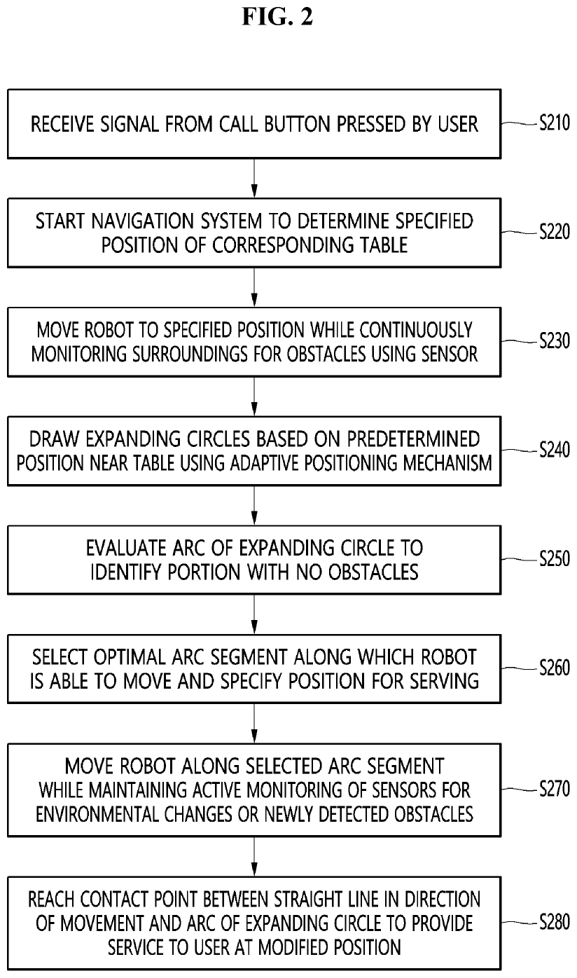

FIG. 2 is a flowchart for describing the operations of a navigation and adaptive positioning process of a robot.

As illustrated in FIG. 2, an adaptive positioning method of the restaurant serving robot of the present invention includes an operation S210 of receiving a signal from a call button pressed by a user, an operation S220 of starting a navigation system to determine a specified position of a corresponding table, an operation S230 of moving the robot to the specified position while continuously monitoring the surroundings for obstacles, an operation S240 of drawing expanding circles based on a predetermined position near the table using an adaptive positioning mechanism, an operation S250 of evaluating an arc of the expanding circle to identify a portion with no obstacles, an operation S260 of selecting an optimal arc segment along which the robot is able to move and specifying a position for serving, an operation S270 of moving the robot along the selected arc segment while maintaining active monitoring of sensors for environmental changes or newly detected obstacles, and an operation S280 of reaching a contact point between a straight line in a direction of movement and the arc of the expanding circle to provide service to the user at a modified position.

Specifically, in operation 210, the robot receives a signal from a call button pressed by the user, and in operation 220, the robot initiates the navigation system 130 to determine a specified position of a corresponding table.

Thereafter, in operation 230, the robot starts to move toward the specified position while continuously monitoring the surroundings for obstacles using sensors.

In operation 240, the adaptive positioning mechanism 140 draws the expanding circles based on the predetermined position near the table.

Thereafter, in operation 250, the robot evaluates the arc of the expanding circle in order to identify a portion with no obstacles.

Thereafter, in operation 260, the robot selects an optimal arc segment along which the robot is able to move along the arc and determines the position for serving.

Thereafter, in operation 270, the robot moves toward the selected arc while maintaining active monitoring of sensors for environmental changes or newly detected obstacles.

Thereafter, in operation 280, the robot reaches a contact point between a straight line in a direction of movement and the arc of the expanding circle.

This contact point becomes a modified position where the robot provides the service to the user.

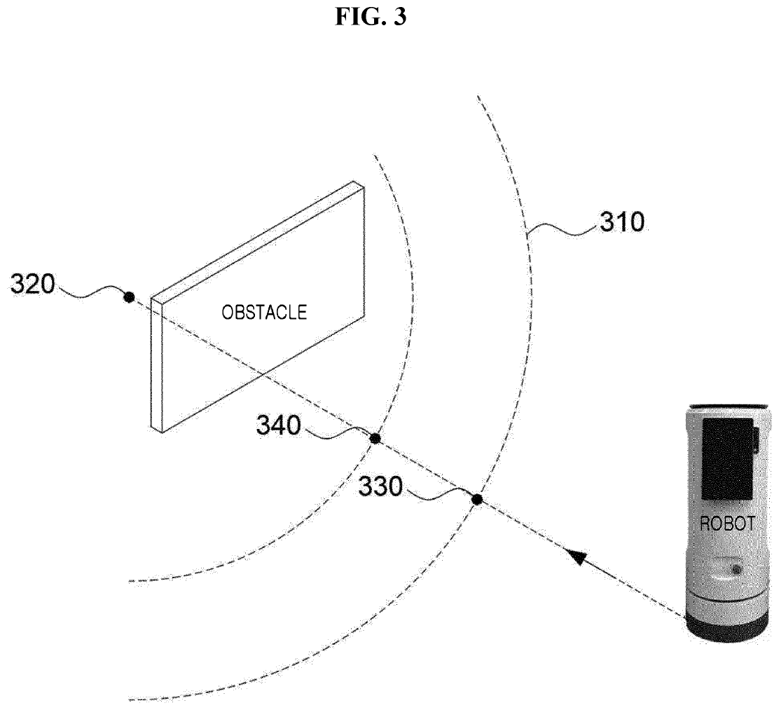

FIG. 3 is a plan view of a serving area showing the expanding circles and arc-based positioning of a robot.

FIG. 3 illustrates a plan view of a serving area illustrating expanding circles 310 and arc-based positioning of the robot, and a predetermined position 320 near a table is used as a reference for drawing the expanding circles 310.

In this case, the robot identifies an optimal arc segment 330 with no obstacles and moves along the optimal arc segment 330 to reach a modified position 340 for serving.

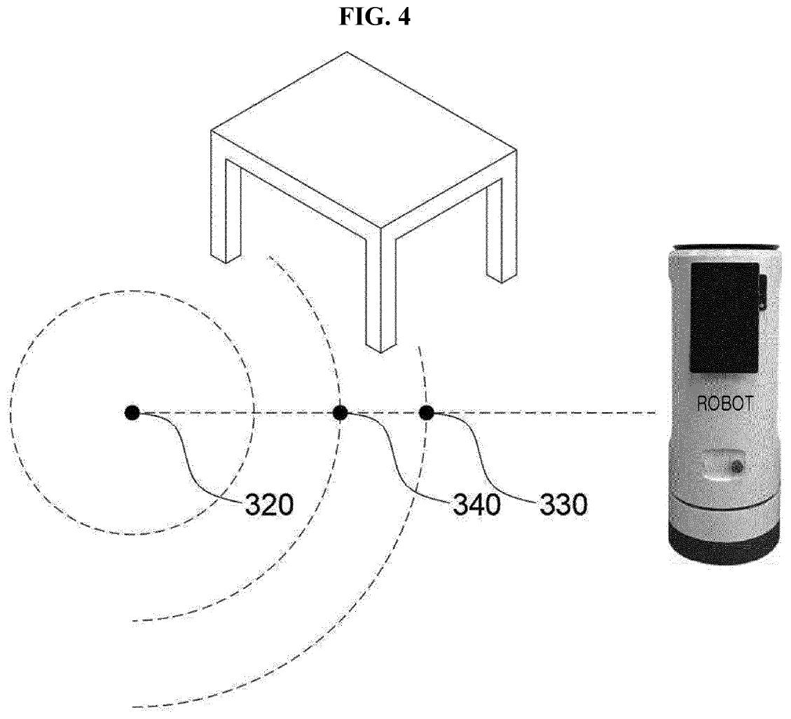

FIG. 4 is a side view of a robot positioned along arcs of expanding circles for optimal serving.

As illustrated in FIG. 4, the wheels 120 of the robot performs a function for being adapted to a curvature of the selected arc segment 330 to allow the robot to move smoothly and maintaining stability while providing the service to the user.

In conclusion, the present invention provides a new restaurant serving robot with an advanced navigation system and adaptive positioning mechanism.

The robot may specify an optimal position in order to avoid obstacles and provide efficient and unhindered service to the user.

It should be understood that the embodiments described herein are only exemplary and that numerous other modifications and changes may be made without departing from the scope and spirit of the present invention as defined in the appended claims.

Meanwhile, the restaurant serving robot, which includes a main body 110, a plurality of wheels 120, a navigation system 130, and an adaptive positioning mechanism 140, moves to the user's table and detects obstacles in its path when receiving a signal from a call button.

The adaptive positioning mechanism draws expanding circles based on a predetermined position near the table, identifies an arc of an expanding circle with no obstacles, allows the robot to move along a selected arc, and specifies an optimal position to provide service to a user.

A contact point between a straight line in a direction in which the robot moves and the arc of the expanding circle becomes a modified position where the robot provides the service to the user.

The following examples serve to illustrate applications and advantages of the present invention.
1) Example 1: In a busy restaurant environment where tables are closely placed and people move around frequently and can be disruptive, the adaptive positioning mechanism of the present invention enables the serving robot to efficiently navigate the environment, and provide service to users without being hindered by obstacles.
2) Example 2: At a special event held in a restaurant where additional furniture or decorations are placed to change a general layout, the restaurant serving robot may adjust its path and position to accommodate the change, and thus ensure seamless service throughout the event.
3) Example 3: In a restaurant with outdoor seating, where environmental factors such as wind or rain may cause unexpected obstacles, such as fallen tree branches or puddles, the serving robot may detect these obstacles and adjust its path accordingly to provide uninterrupted service to customers.

The above-described examples are provided for illustrative purposes only and are not intended to limit the scope of the present invention. Various modifications and applications may be made to suit a specific environment or application without departing from the spirit and scope of the present invention as defined in the claims.

The components will be described in detail below.
1) Control system: The control system of the restaurant serving robot is responsible for processing data input from the navigation system and the adaptive positioning mechanism, interprets the data, generates an appropriate command for controlling the robot's movement, and ensures efficient navigation and positioning during the service.
2) Power source: The power source of the restaurant serving robot may be a rechargeable battery such as a lithium-ion battery, and may provide enough energy for the robot to operate for a long period of time.

The power source may be integrated with a charging mechanism that can recharge the robot when not in use or when its battery level is low.
3) Serving tray: The serving tray is a component of the robot designed to transport food and drinks from the kitchen to the user's table.

The serving tray is adjustable to accommodate plates, glasses and other items of different sizes and shapes, and the serving tray may be integrated with an anti-spill mechanism to prevent food and drinks from spilling during transport.
4) Camera: The camera integrated with the navigation system captures visual data around the robot.

This data is processed by the control system so that obstacles are identified and the robot's position and orientation within the restaurant are determined.
5) LIDAR sensor: The LIDAR sensor illuminates an object with laser light, and measures a distance by measuring reflected light.

The LIDAR sensor provides high-resolution three-dimensional data around the robot to enable accurate obstacle detection and path planning.
6) Ultrasonic sensor: The ultrasonic sensor emits high-frequency sound waves, and the sound waves reflect off an obstacle and return to the sensor, and the ultrasonic sensor measures the time it takes for the sound waves to travel to the obstacle and return, and thus the robot may calculate a distance to the obstacle so that its ability to detect and avoid the obstacle may be further improved.

In addition to the above-described examples and components, the present invention may also include various alternative examples and features, including the following.
1) Alternative navigation system: The restaurant serving robot may utilize an alternative or additional navigation system, such as a Global Positioning System (GPS) or a simultaneous localization and mapping (SLAM) or computer vision algorithm, to improve its ability to navigate complex environments and accurately determine position and orientation.
2) Obstacle avoidance techniques: The robot may use additional or alternative obstacle avoidance techniques, such as path planning algorithms, machine learning models, or artificial intelligence algorithms, in order to improve its ability to avoid obstacles and navigate efficiently.
3) Communication system: The restaurant serving robot may be equipped with a communication system that can communicate with other robots, restaurant staff, or a central control system.

The communication system may improve overall restaurant efficiency by improving coordination between the serving robot and staff.
4) User interface: The robot may be integrated with a user interface, such as a touch screen or voice recognition system, so that the user may directly interact with the robot.

The user interface may facilitate tasks such as taking orders, answering questions, or providing recommendations.
5) Customizable design: The user may customize the robot's shape and design to match the restaurant's theme or brand.

The customizable design may include different colors, shapes, or branding elements to provide a consistent and visually appealing experience to the user.
6) Additional sensors: The robot may be integrated with an additional sensor, such as an infrared sensor, a thermal sensor, or a pressure sensor, to improve its ability to detect obstacles, interact with users, or monitor environments.

The alternative examples and features described above may be independently combined or implemented to suit specific needs, environments, or applications without departing from the scope and spirit of the present invention as defined in the appended claims.

In the following, operation and maintenance will be described.

It is possible to facilitate the operation and maintenance of the restaurant serving robot through various processes and systems designed to ensure efficient and reliable performance.
1) Initialization and calibration: Before deployment, the restaurant serving robot may undergo initialization and calibration processes to check whether the navigation system and the adaptive positioning mechanism are operating correctly.

The initialization and correction processes may include setting reference points, mapping the restaurant layout, or calibrating sensors and actuators.
2) Regular software updates: The control system and algorithms that are used by the robot may be updated regularly to integrate improvements, bug fixes, or new features.

The software update may be provided remotely or manually, depending on the robot's communication capability.
3) Diagnosis and troubleshooting: The restaurant serving robot may be equipped with self-diagnosis and troubleshooting capabilities that can detect and report problems or malfunctions.

The diagnosis and troubleshooting enable proactive maintenance and rapidly resolve any problems that may arise during operation.
4) Cleaning and sanitation: Regular cleaning and sanitization of the robot's serving tray and other components that come in contact with food and beverages is essential to maintain hygiene standards.

The cleaning and sanitation may include manual cleaning by restaurant staff or an automated cleaning system integrated into robotic design.
5) Battery management: Appropriate battery management, including regular charging and replacement, when necessary, may ensure that the robot operates efficiently and reliably.

The robot may be equipped with a battery monitoring system that alerts the staff when the battery needs to be recharged or replaced.
6) Staff training: The restaurant staff may require training on how to operate, maintain and interact with the serving robot.

The staff training may include understanding the robot's capabilities, limitations, and safety features, as well as best practices for working with the robot in a restaurant environment.

The above-described operation and maintenance procedures may be adjusted to specific needs and requirements of each restaurant, and ensure that the serving robot performs optimally and provides an excellent user experience.

In the following, environmental adaptability will be described.

The restaurant serving robot may be adjusted to operate in various environments, including various types of restaurants and dining environments.

The following features and considerations may promote robot adaptability.
1) Indoor and outdoor operation: The robot may be designed to operate effectively in both indoor and outdoor environments.

The indoor and outdoor operation may include using weather-resistant materials and components and designing robots to handle different terrain types, such as uneven ground or slopes.
2) Multi-level operation: The robot may be configured to navigate multi-level dining spaces, such as multi-floor restaurants or tiered seating arrangements.

The multi-level operation may include incorporating features such as stair climbers, elevators, or ramps to ensure smooth navigation between floors.
3) Customizable navigation and positioning algorithm: The robot's navigation and adaptive positioning algorithm may be customized to fit each restaurant's specific layout and requirements.

The customizable navigation and positioning algorithm may include adjusting parameters such as the size of the expanding circle, the sensitivity of obstacle detection, or the path planning logic to accommodate unique environments.
4) Scalability: The restaurant serving robot system may be expanded to accommodate various restaurant sizes and capacities.

The scalability may include deploying multiple robots in a larger restaurant or integrating their operations with other restaurant management systems to provide service and optimize efficiency.
5) Integration with existing infrastructure: The robot may be designed to be integrated with existing restaurant infrastructure, such as a table reservation system, a point of sale (POS) system, or a kitchen management system.

The integration with existing infrastructure may help streamline overall operations and improve user experience.

In the following, integration with additional features will be described.

The restaurant serving robot may be designed to be integrated with additional features to enhance usability and improve the overall dining experience for users.

These additional features may include:
1) Order reception: The robot may be equipped with an integrated order reception system such as a touch screen interface or a voice recognition system.

The integrated order reception system allows customers to order directly through the robot, which streamlines the ordering process and reduces the need for manual intervention from restaurant staff.
2) Payment processing: The robot may integrate payment processing functions, and allow customers to complete transactions directly through the robot.

The payment processing may include accepting various payment methods, such as credit cards, mobile payments, or contactless transactions.
3) Entertainment function: The robot may be designed to provide entertainment options to customers, such as playing music, displaying multimedia content, or engaging in interactive games.

The entertainment function may improve the overall dining experience and increase customer satisfaction.
4) Customer support: The robot may provide customer support, such as answering questions about menus, providing recommendations, or handling special requests.

The customer support may be facilitated through natural language processing and artificial intelligence capabilities integrated into the robot's control system.
5) Clearing and cleaning tables: The robot may be equipped with an additional feature to clear and clean tables after customers have finished eating.

The clearing and cleaning of tables may involve incorporating sensors and actuators to identify and remove used plates, utensils, and other debris and deploying cleaning mechanisms to disinfect table surfaces.
6) Food and beverage preparation: In a specific embodiment, the robot may be designed to assist with food and beverage preparation tasks, such as mixing drinks, assembling salads, or portioning desserts.

The food and beverage preparation may be facilitated through the integration of additional sensors and control systems, as well as the use of special attachments and tools.

The above-described additional features may be combined or implemented independently to enhance the capabilities of the restaurant serving robot without departing from the scope and spirit of the present invention as defined in the appended claims.

While the present invention has been described in terms of specific embodiments, components and examples, it should be understood that various modifications, adaptations, and changes may be made without departing from the scope and spirit of the invention as defined in the appended claims.

The present invention is not limited to the specific embodiments and examples disclosed herein, and its scope is intended to include all aspects falling within the scope of the claims.

In the following, an example of the obstacle avoidance restaurant serving robot with adaptive positioning will be described.

In order to find a point where an arc of a circle expanding to 30 and an equation of a straight line that moves the robot toward a fixed position (0,0) meet, an equation of a straight line connecting a current position (100,100) of the robot should be first obtained.

Equation of straight line:

An equation of a straight line is given by y=mx+b, where m is a slope and b is a y-intercept.

Since the line connects points (100,100) and (0,0), the slope m may be found as follows.

$$m = ( y 2 - y 1 ) / ( x 2 - x 1 ) = ( 100 - 0 ) / ( 100 - 0 ) = 100 / 100 = 1$$

Since the line passes through the origin (0,0), the y-intercept b is 0.

Therefore, the equation of the straight line is as follows.

y=x

In this case, a center and radius of the expanding circle are determined.

The expanding circle is centered at a fixed position (0,0) and initially expands to a radius of 30.

Therefore, an equation of the expanding circle is as follows.

$${x}^{2} + {y}^{2} = 3 {0}^{2} = 900$$

Find contact point:

In order to find a contact point between a straight line and an expanding circle, a system of equations should be solved.

$$y = x$$

$${x}^{2} + {y}^{2} = 900$$

The first equation is substituted into the second equation.

$${x}^{2} + {x}^{2} = 900$$

Solve for x:

$$2 {x}^{2} = 900$$

$${x}^{2} = 450$$

$$x = \pm √ 450 = \pm 21.21$$

Since the robot moves toward the fixed position (0,0), a positive value should be selected for x.

x≈21.21

In this case, the corresponding y coordinate (since y=x) is found.

y≈21.21

Therefore, the point where the arc of the expanding circle meets the equation of the straight line along which the robot moves toward the fixed position (0,0) is approximately (21.21, 21.21).

For verification purposes, another example is given.

In order to find a point between an arc of a circle expanding to √2*30 and an equation of a straight line that moves the robot toward a fixed position (0,0) meet, an equation of a straight line connecting a current position (100,100) of the robot should be first obtained.

Equation of straight line:

An equation of a straight line is given by y=mx+b, where m is a slope and b is a y-intercept.

Since the line connects points (100,100) and (0,0), the slope m may be found as follows.

$$m = ( y 2 - y 1 ) / ( x 2 - x 1 ) = ( 100 - 0 ) / ( 100 - 0 ) = 100 / 100 = 1$$

Since the line passes through the origin (0,0), the y-intercept b is 0.

Therefore, the equation of the straight line is as follows.

y=x

A center and radius of the expanding circle are determined.

The expanding circle is centered at a fixed position (0,0) and initially expands to a radius of √2*30. Therefore, an equation of the expanding circle is as follows.

$${x}^{2} + {y}^{2} = {( √ 2 * 30 )}^{2} = {( 30 √ 2 )}^{2} = 900 * 2 = 1 , 800$$

Find contact point:

In order to find a contact point between a straight line and an expanding circle, a system of equations should be solved.

$$y = x$$

$${x}^{2} + {y}^{2} = 1 , 800$$

The first equation is substituted into the second equation as follows.

$${x}^{2} + {x}^{2} = 1 , 800$$

Solve for x:

$$2 {x}^{2} = 1 , 800$$

$${x}^{2} = 900$$

$$x \approx \pm √ 900 \approx \pm 30$$

Since the robot moves toward the fixed position (0,0), a positive value should be selected for x.

x≈30

In this case, the corresponding y coordinate (since y=x) is found.

y≈30

Therefore, the point where the arc of the expanding circle meets the equation of the straight line along which the robot moves toward the fixed position (0,0) is approximately (30, 30).

According to the present invention, a new restaurant serving robot equipped with an advanced navigation system and an adaptive positioning mechanism is provided.

Further, the robot of the present invention may move to a user's table when a call button is pressed, detect obstacles in its path, and adjust its position accordingly to maintain efficient and unhindered service.

According to the present invention having the components and operation described above, a new restaurant serving robot equipped with an advanced navigation system and an adaptive positioning mechanism can be provided.

Further, the robot of the present invention can move to a user's table when a call button is pressed, detect obstacles in its path, and adjust its position accordingly to maintain efficient and unhindered service.

It will be understood by those skilled in the art that the present invention may be implemented in other specific forms without changing its technical idea and essential features. Therefore, the above-described embodiments should be considered in a descriptive sense only and not for purposes of limitation.

The scope of the present invention is defined not by the detailed description but by the appended claims, and encompasses all modifications and alterations derived from meanings, the scope and equivalents of the appended claims.

What is claimed is:

1. An obstacle avoidance restaurant serving robot with adaptive positioning, comprising:
a main body (110) configured to accommodate components of the robot, including a control system, a power source, and a serving tray (150);
a plurality of wheels (120) formed on a lower side of the main body to move and support the main body;
a navigation system (130) which includes sensors such as a camera, a light detection and ranging (LIDAR) sensor, an ultrasonic sensor, etc. to determine a position of the robot and allow the robot to move to a user's table when a signal is received from a call button; and
an adaptive positioning mechanism (140) configured to draw expanding circles based on a predetermined position near the user's table, identify an arc of an expanding circle with no obstacles, allow the robot to move along a selected arc, and specify an optimal position in order to provide service to the user.

2. An adaptive positioning method of a restaurant serving robot, comprising:
an operation (S210) of receiving a signal from a call button pressed by a user;
an operation (S220) of starting a navigation system to determine a specified position of a corresponding table;
an operation (S230) of moving the robot to the specified position while continuously monitoring the surroundings for obstacles;
an operation (S240) of drawing expanding circles based on a predetermined position near the table using an adaptive positioning mechanism;
an operation (S250) of evaluating an arc of the expanding circle to identify a portion with no obstacles;
an operation (S260) of selecting an optimal arc segment along which the robot is able to move and specifying a position for serving;
an operation (S270) of moving the robot along the selected arc segment while maintaining active monitoring of sensors for environmental changes or newly detected obstacles; and
an operation (S280) of reaching a contact point between a straight line in a direction of movement and the arc of the expanding circle to provide service to the user at a modified position.
